(19) United States
(12) Patent Application Publication
(10) Pub. No.: US 2004/0043248 A1
(43) Pub. Date: Mar. 4, 2004

(54) Phosphorescent elecret films and methods of making the same

(75) Inventor: Vivek Bharti, West St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/231,506

(22) Filed: Aug. 30, 2002

(51) Int. Cl. B32B 9/00

(52) U.S. Cl. 428/690; 428/323

(57) ABSTRACT

A phosphorescent film comprises a mixture of at least one thermoplastic polymer and at least one phosphorescent pigment, wherein the mixture has an electret charge. Multilayer phosphorescent films having an electret charge, and methods for making the same are also disclosed.

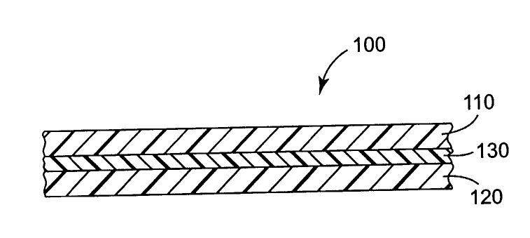

### TECHNICAL FIELD

The present invention generally relates to phosphorescent films.

### BACKGROUND

The term “cling film” is commonly used to refer to a film that can cling to a substrate without the use of adhesives or fasteners. Cling films are generally divided into two major types: cling vinyl films and electret films.

Cling vinyl films (also known as “static cling vinyl” films) typically contain plasticizers and/or tackifiers, and can typically be adhered to smooth, rigid surfaces such as glass windows, but may not adhere well to porous, rough and/or dusty surfaces. In addition, plasticizers and/or tackifiers that are present in cling vinyl films may diffuse out of the film and leave a residue or on, or otherwise damage, a substrate to which the film is bonded. Phosphorescent (i.e., “glow in the dark”) cling vinyl films are known and are commercially available.

An “electret” is a material having a permanent or semi-permanent electrostatic charge (i.e., electret charge). Electret films typically exhibit electrostatic attraction (i.e., static cling) to surfaces of substrates thereby allowing the films to be removably adhered to such surfaces without the need for added tackifiers and/or plasticizers.

“Glow in the dark” behavior may typically be achieved using phosphorescent pigment. The luminosity (i.e., phosphorescence intensity) of phosphorescent pigments typically is a function of the pigment particle size, with larger particle sizes exhibiting brighter luminescence. However, the requirements of typical ink formulations require phosphorescent pigments having an average pigment particle size reduced to such a degree that luminosity is substantially decreased. For most applications, it is desirable that phosphorescent pigments have as high a luminosity as possible, either to enable using less of the, typically expensive, phosphorescent pigment and/or to improve visibility and duration of the phosphorescence.

It would be desirable to have phosphorescent cling films with good luminosity that adhere to rough and/or dusty surfaces, and do not leave residue on surfaces to which they may be adhered.

### SUMMARY

In one aspect, the present invention provides a phosphorescent film comprising a mixture of at least one thermoplastic polymer and at least one phosphorescent pigment, wherein the mixture has an electret charge. In one embodiment of this aspect of the present invention, the phosphorescent film comprises:

a first layer comprising a first mixture comprising a first thermoplastic polymer and phosphorescent pigment; and

a second layer secured to the first layer, wherein the second layer comprises a second mixture comprising a second thermoplastic polymer and reflective pigment, wherein at least one of the first and second layers has an electret charge.

In another aspect, the present invention provides a method of making a phosphorescent electret film comprising the step of extruding a mixture of at least one thermoplastic polymer and at least one phosphorescent pigment.

In another aspect, the present invention provides a method for adhering a phosphorescent electret film to a substrate comprising:

providing a phosphorescent electret film; and

electrostatically and removably adhering the phosphorescent electret film to the substrate.

Phosphorescent electret films according to the present invention typically adhere to rough and/or dusty surfaces, may have long lasting phosphorescence, and typically do not leave a residue if removed.

As used herein:

“film” refers to a continuous thin layer, and includes for example, rolls, sheets, tapes, and strips;

“removably adhered” means separable by peeling, without substantial damage (e.g., tearing) to the objects being separated;

“(meth)acryl” includes acryl and methacryl; and

“ionomer” refers to a polymer having carboxyl groups wherein at least some of the acidic protons have been replaced (i.e., neutralized) by metal ions.

### BRIEF DESCRIPTION OF THE DRAWING

The drawing is a cross-sectional view of an exemplary phosphorescent electret film according to one embodiment of the present invention.

### DETAILED DESCRIPTION

Phosphorescent electret films of the present invention typically have at least one layer that comprises at least one thermoplastic polymer, phosphorescent pigment, and at least one optional additive.

Any thermoplastic polymeric material that can maintain an electret charge can be used to make the phosphorescent electret film, including fluorinated polymers (e.g., polytetrafluoroethylene, polyvinylidene fluoride, tetrafluoroethylene-hexafluoropropylene copolymers, vinylidene fluoride-trifluorochloroethylene copolymers), polyolefins (e.g., polyethylene, polypropylene, poly-4-methyl-1-pentene, propylene-ethylene copolymers), copolymers of olefins and other monomers (e.g., ethylene-vinyl acetate copolymers, ethylene-acrylic acid copolymers, ethylene-maleic acid anhydride copolymers, propyleneacrylic acid copolymers, propylene-maleic acid anhydride copolymers, 4-methyl-1-pentene-acrylic acid copolymers, 4-methyl-1-pentene-maleic acid anhydride copolymers), ionomers (e.g., ethylene-(meth)acrylic acid copolymers with acidic protons replaced by Na⁺, K⁺, Ca²⁺, Mg²⁺, or Zn²⁺ cations), polyesters (e.g., polyethylene terephthalate), polyamides (e.g., nylon-6, nylon-6,6), polycarbonates, polysulfones, non-plasticized polyvinyl chloride, blends and mixtures thereof, and the like. Desirably, the thermoplastic polymeric material comprises at least one of polypropylene or a poly(ethylene-comethacrylic acid) ionomer, more desirably a poly(ethylene-co-methacrylic acid) ionomer, more desirably a zinc poly(ethylene-co-methacrylic acid) ionomer.

Many poly(ethylene-co-(meth)acrylic acid) ionomers are commercially available as pellets and/or films, for example, as marketed under the trade designation “SURLYN” (e.g., lithium poly(ethylene-co-methacrylic acid) ionomers such as “SURLYN 7930”, “SURLYN 7940”; sodium poly(ethylene-co-methacrylic acid) ionomers such as “SURLYN 1601”, “SURLYN 8020”, “SURLYN 8120”, “SURLYN 8140”, “SURLYN 8150”, “SURLYN 8320”, “SURLYN 8527”, “SURLYN 8660”, “SURLYN 8920”, “SURLYN 8940”, “SURLYN 8945”, zinc poly(ethylene-co-methacrylic acid) ionomers such as “SURLYN 1705-1”, “SURLYN 1706”, SURLYN 6101”, SURLYN 9020”, “SURLYN 9120”, “SURLYN 9150”, “SURLYN 9320W”, “SURLYN 9520”, “SURLYN 9650”, “SURLYN 9720”, “SURLYN 9721”, “SURLYN 9910”, “SURLYN 9945”, “SURLYN 9950”, “SURLYN 9970”, “SURLYN PC-100”) by E. I. du Pont de Nemours & Company, Wilmington, Del.; or as marketed under the trade designation “IOTEK” (e.g., sodium poly(ethylene-co-acrylic acid) ionomers such as “IOTEK 3110”, “IOTEK 3800”, or “IOTEK 8000”, and zinc poly(ethylene-co-acrylic acid) ionomers such as “IOTEK 4200”) by ExxonMobil Corporation, Houston, Tex. Further details of useful poly(ethylene-co-(meth)acrylic acid) ionomers are described in, for example, commonly assigned U.S. patent application entitled “METHOD OF ADHERING A FILM AND ARTICLES THEREFROM” (Bharti et al.), bearing Attorney Case No. 57946US002, filed concurrently herewith, the disclosure of which is incorporated herein by reference.

Typically, phosphorescent pigments suitable for use in practice of the present invention are particulate in nature. Useful phosphorescent pigments include any phosphorescent pigments known in the art. Exemplary phosphorescent pigments include zinc phosphors (e.g., zinc cadmium sulfide phosphors, zinc copper sulfide phosphors, zinc silicate phosphors, zinc sulfide cadmium phosphors), calcium phosphors (e.g., calcium strontium sulfide phosphors, calcium sulfide phosphors, calcium tungstate phosphors), strontium phosphors (e.g., strontium sulfide phosphors), and rare earth metal phosphors (e.g., rare earth doped strontium aluminate), and combinations thereof. Further details regarding useful phosphorescent pigments may be found in, for example, U.S. Pat. No. 6,423,247 B1 (Fukushima et al.) and U.S. Pat. No. 6,375,864 (Phillips et al.), and U.S. Patent Publication No. 2001/0010367 A1 (Bumell-Jones), published Aug. 2, 2001.

Typically, the total amount of phosphorescent pigment(s) mixed with the thermoplastic polymer is in a range of from about 1 percent to about 70 percent by volume, preferably in a range of from about 5 percent to about 50 percent by volume, more preferably in a range of from about 10 percent to about 30 percent by volume, based on the total volume of the mixture of thermoplastic polymer and phosphorescent pigment, although greater and lesser relative amounts of phosphorescent pigment to thermoplastic polymer may also be used.

Typically, phosphorescent pigments used in practice of the present invention have an average particle size of at least about 5 micrometers, preferably greater than about 20 micrometers, more preferably greater than about 30 micrometers, although phosphorescent pigments with lesser average particle sizes may also be used. Typically, phosphorescent pigments used in practice of the present invention have an average particle size of less than about 100 micrometers, preferably less than about 80 micrometers, more preferably less than about 50 micrometers, although pigments with greater average particle sizes may also be used.

Many phosphorescent pigments are commercially available, for example, from ProGlow Manufacturing Company, Pleasant, Pa.; USR Optonix, Hackettstown, N.J.; or Shannon Luminous Materials, Santa Ana, Calif. At least one dye (e.g., fluorescent dye) may optionally be combined with the phosphorescent pigment to achieve different luminescent colors.

Exemplary optional additives include antioxidants, light stabilizers (e.g., as available from Ciba Specialty Chemicals, Tarrytown, N.Y., under the trade designations “CHIMASSORB 2020”, “CHIMASSORB 119”, “CHIMASSORB 944”, “TINUVIN 783”, or “TINUVIN C 353”), thermal stabilizers (e.g., as available from Ciba Specialty Chemicals under the trade designations “IRGANOX 1010”, “IRGANOX 1076”), fillers (e.g., inorganic or organic), charge control agents (e.g., as described in U.S. Pat. No. 5,558,809 (Groh et al.)), fluorochemical additives (e.g., as described in U.S. Pat. No. 5,976,208 (Rousseau et al.) and U.S. Pat. No. 6,397,458 (Jones et al.)), glass beads, glass bubbles, colorants (e.g., dyes, pigments (including phosphorescent pigments), and fragrances.

Preferably, phosphorescent electret films according to the present invention are at least substantially free of plasticizers and/or tackifiers.

In one embodiment of the present invention, the phosphorescent electret film may be a single layer.

In one embodiment of the present invention, the phosphorescent electret film may be a combination of at least two separate films that are joined together (e.g., heat laminated, adhesively bonded, coextruded). This embodiment is illustrated by the drawing, wherein phosphorescent electret film 100 has phosphorescent layer 110 and reflective layer 120. Optional adhesive layer 130, is disposed between and contacts phosphorescent layer 110 and reflective layer 120. In this embodiment, phosphorescent layer 110 typically comprises a mixture of a thermoplastic polymer and phosphorescent pigment, while reflective layer 120 comprises a mixture of thermoplastic polymer and reflective pigment. Optional adhesive layer 130, preferably comprises a transparent or translucent adhesive (e.g., hot melt adhesive, pressure-sensitive adhesive, glue). Preferably, phosphorescent layer 110 and reflective layer 120 are coextruded.

The reflective layer typically comprises a thermoplastic polymer and a light colored pigment (e.g., white, pale yellow, pale green, or off-white). Exemplary light colored pigments include oxides of titanium, oxides of barium, and oxides of aluminum. Preferably, the light colored pigment comprises titanium dioxide.

Typically, the amount of light colored pigment in the reflective layer is in a range of from about 10 to about 50 volume percent based on the total volume of the reflective layer, although other amounts may also be used.

Phosphorescent electret films according to the present invention may be perforated or non-perforated.

Typically, phosphorescent electret films used in practice of the present invention have a thickness in a range of from about 10 micrometers to about 2500 micrometers, although thinner and thicker films may also be used. Preferably, phosphorescent electret films have a thickness in the range of from about 25 micrometers to about 310 micrometers, more preferably in the range of from about 50 micrometers to about 110 micrometers. In embodiments of the present invention, wherein a phosphorescent layer and a reflective layer are present, the layers may be of any relative thickness.

The phosphorescent electret film may optionally have an image on at least one major surface thereof. The image may comprise, for example, at least one graphic image, alphanumeric character, and/or other indicia. The image may be printed (e.g., by inkjet printing, electro(photo)graphy, letter press, flexography, thermal transfer printing, screen printing, lithographic printing) or created by other means (e.g., laser marking).

Optionally, an image-receiving layer may be coated on, or otherwise affixed to, at least a portion of the phosphorescent electret film. Such a layer may be applied to an entire major surface of the phosphorescent electret film, or only a portion thereof. The optional image may, for example, be disposed on the outermost surface of, and/or contained within, the image-receiving layer.

Procedures for extruding (including coextruding) thermoplastic polymers are well known in the art, and are described in, for example, U.S. Pat. No. 5,486,949 (Schrenk et al.) and U.S. Pat. No. 5,968,666 (Carter et al.), the disclosures of which are incorporated herein by reference. Thermoplastic polymers may be extruded in pure form, or as a mixture with at least one additional component (e.g., phosphorescent pigment, light colored pigment). If extruding a mixture of a thermoplastic polymer and phosphorescent pigment, the process is preferably carried out using a minimum of temperature and/or shear, to minimize or avoid degradation of the pigment.

Phosphorescent electret films according to the present invention typically have an electret charge. Preferably, the electret is formed (e.g., by direct current (i.e., DC) corona charging) subsequent to any printing, coating, and/or heat lamination steps that may be involved in producing articles according to the present invention, although the electret may be formed at other stages of the manufacturing process.

Electret formation can be accomplished by a variety of methods that are well known in the art. For details on methods for forming electrets, see, for example, “Electrets”, G. M. Sessler (ed.), Springer-Verlag, New York, 1987. Exemplary methods of forming electrets are well known in the art, and include thermal electret, electroelectret, radioelectret, magnetoelectret, photoelectret and mechanical electret forming methods as described in, for example, U.S. Pat. No. 5,558,809 (Groh et al.), the disclosure of which is incorporated herein by reference. Typically, phosphorescent electret films utilized in practice of the present invention have an electret charge density of greater than about 0.05 nanocoulombs per square centimeter (nC/cm²), preferably greater than about 0.5 nC/cm², more preferably greater than about 5 nC/cm². DC corona charging (e.g., as described in, for example, U.S. Pat. No. 6,001,299 (Kawabe et al.) and U.S. Pat. No. 4,623,438 (Felton et al.), the disclosures of which are incorporated herein by reference) is a preferred method for forming the electret.

In some embodiments of the present invention, such as those in which strong bonding is undesirable (e.g., bonding to fragile substrates), it is preferable that one or more surfaces of the phosphorescent electret film be free of adhesive or latent adhesive that might adhere to the substrate over time. Such adhesion may lead to unwanted adhesive residues and/or damage upon separation of the phosphorescent electret film from the substrate.

According to one embodiment of the present invention, phosphorescent electret films useful in practice of the present invention, may typically be contacted with a substrate, thereby electrostatically and removably adhering them to that substrate.

Any solid substrate may be used in practicing the present invention. The substrate may be conductive or nonconductive. Preferably, at least the portion of the surface of the substrate that contacts the article is substantially planar. As used herein, the term “substantially planar” encompasses surfaces that are generally planar in appearance, optionally having minor irregularities, imperfections and/or warpage. Suitable substrates may have vertical and/or horizontal surfaces, and may be painted or unpainted. Exemplary substrates include backing sheets and liners (e.g., papers, thermoplastic polymer films), multilayer optical films (e.g., as described in for example U.S. Pat. No. 5,825,543 (Ouderkirk et al.) and U.S. Pat. No. 5,783,120 (Ouderkirk et al.), the disclosures of which are incorporated by reference), architectural surfaces (e.g., floors, walls, ceilings), glass (e.g., windows, mirrors), metal, drywall, plaster, motor vehicles (e.g., automobiles, trucks, motorcycles), trailers (e.g., truck trailers), mobile homes, boats, furniture (e.g., wicker furniture), boxes, cabinets, mats, wall hangings, doors, dishes (e.g., glasses, plates, and ceramic dishes), ceramic tile, photographs, banners, balloons, signs, paper, and cloth. Preferably, the substrate is non-conductive (i.e., a dielectric), although this is not a requirement.

Typically, the phosphorescent electret film may be removably adhered to a substrate by contacting a major surface of the phosphorescent electret film with a surface of the substrate, sliding the phosphorescent electret film to a desired orientation and/or position, and then smoothing out wrinkles and/or bubbles in the film. After any optional smoothing, the phosphorescent electret film is preferably rubbed (e.g., with a woven or nonwoven cloth) as described in commonly assigned U.S. patent application entitled “METHOD FOR ELECTROSTATICALLY ADHERING AN ARTICLE TO A SUBSTRATE” (Bharti et al.), bearing Attorney Case No. 57949US002, filed concurrently herewith, the disclosure of which is incorporated herein by reference. Such rubbing typically serves to increase the level of adhesion (e.g., shear adhesion) between the phosphorescent electret film and the substrate.

The present invention will be more fully understood with reference to the following non-limiting examples in which all parts, percentages, ratios, and so forth, are by weight unless otherwise indicated.

### EXAMPLES

In the following examples, ambient conditions were temperatures in a range of from 21° C. to 23° C., with relative humidity in a range of from 10 percent to 70 percent.

### Example 1

A charged film was prepared by coextruding a two-layer film onto a 1.4 mil (36 micrometers) thick polyester liner (polyethylene terephthalate containing 0.5 percent by weight aluminum silicate). The two-layer film had a top layer and a bottom layer (the bottom layer contacted the polyester liner). The two layers were coextruded through a dual manifold two slot die heated at a temperature of 440° F. (227° C.). Each manifold of the two slot die was fed by a mixture extruded from a separate 1.25 inch (3.2 cm) Killion Model KL-125 single screw extruder available from Davis-Standard Corporation, Killion Extruders Division, Pawcatuck, Conn.; zone 1=350° F. (177° C.); zone 2=420° F. (216° C.); zone 3=440° F. (227° C.).

As coextruded, the top layer had a thickness of 1 mil (25 micrometers), and consisted of a mixture of 70 parts zinc poly(ethylene-co-methacrylic acid) ionomer (obtained as pellets under the trade designation “SURLYN 1706” from E. I. du Pont de Nemours & Company) with 75 parts of a phosphorescent pigment concentrate. The phosphorescent pigment concentrate consisted of 50 percent by weight phosphorescent pigment in ethylene vinyl acetate copolymer (obtained under the trade designation “UG6-50” from ProGlow Manufacturing Company).

As coextruded, the bottom layer had a thickness of 1 mil (25 micrometers), and consisted of a mixture of 70 parts zinc poly(ethylene-co-methacrylic acid) ionomer (obtained as pellets under the trade designation “SURLYN 1706” from E. du Pont de Nemours & Company) and 30 parts by weight of a white pigment concentrate. The white pigment concentrate had 70 percent by weight titanium dioxide and 30 percent by weight polyethylene, and was obtained under the trade designation “STANDRIDGE 11937 WHITE CONCENTRATE” from Standridge Color, Bridgewater, N.J.).

The liner was removed from a sample,(8.5 inches×11 inches (22 cm×28 cm) of the coextruded film prepared above, and the film was then DC corona charged under ambient conditions. Film samples were corona charged using a horizontally arranged series of four charging bars (obtained under the trade designation “CHARGEMASTER PINNER ARC RESISTANT CHARGING BAR” from Simco Company, Hatfield, Pa.). The charging bars were spaced as follows: the center to center distance between bar 1 and bar 2 was 3.0 inches (7.6 cm), the center to center distance between bar 2 and bar 3 was 3.25 inches (8.3 cm), and the center to center distance between bar 3 and bar 4 was 3.75 inches (9.5 cm). Each charging bar was situated 1.5 inches (3.5 cm) above a corresponding grounded metal plate. A voltage of +29 kilovolts (relative to the grounded metal plates) was applied to each charging bar.

Film samples were charged by placing them on a moving (one foot per minute (1.8 meters per minute)) continuous belt (part number: 8882802A, obtained from Light Weight Belting Corporation, Minneapolis, Minn.) that passed between the charging bars and the metal plates, such that the belt maintained contact with the metal plates. During charging the top layer of the film faced the belt.

### Example 2

A charged film was prepared according to the procedure for Example 1, except that the top layer and the bottom layer were each 2 mils (50 micrometers) thick.

### Example 3

A charged film was prepared according to the procedure of Example 1, except that the top layer consisted of only UG6-50 phosphorescent pigment concentrate, and contained no SURLYN 1706 ionomer.

### Example 4

A charged film was prepared according to the procedure of Example 3, except that the top layer and the bottom layer were each 2 mils (50 micrometers) thick.

### Example 5

Charged films of Examples 1-4 and a commercially available phosphorescent film (Comparative Example A, obtained under the trade designation “COLOR CLINGS GLOW IN THE DARK”, Item No. 8648040-ZC91, from Paper Magic Group, Scranton Pa., believed to be cling vinyl film printed with phosphorescent ink) were placed onto a vertical painted drywall surface. The films of Examples 1-4 each adhered to the drywall surface while the film of Comparative Example A would not adhere.

Pieces of films of Examples 1-4 and Comparative Example A were placed on a table top with the phosphorescent layer facing up. The film pieces were simultaneously exposed to light from a fluorescent lamp for 5 minutes. The samples were then covered with a cardboard box having a small viewing window and observed over time. The film of Comparative Example A did not visibly phosphoresce, while the films from Examples 1-4 visibly phosphoresced for at least 5 minutes.

Various modifications and alterations of this invention will become apparent to those skilled in the art without departing from the scope and spirit of this invention, and it should be understood that this invention is not to be unduly limited to the illustrated embodiments set forth herein.

What is claimed is:

1. A phosphorescent film comprising a mixture of at least one thermoplastic polymer and at least one phosphorescent pigment, wherein the mixture has an electret charge.

2. The phosphorescent film of claim 1, wherein the phosphorescent film comprises:
a first layer comprising a first mixture comprising a first thermoplastic polymer and at least one phosphorescent pigment; and
a second layer secured to the first layer, wherein the second layer comprises a second mixture comprising a second thermoplastic polymer and at least one reflective pigment, wherein at least one of the first and second layers has an electret charge.

3. The phosphorescent electret film of claim 2, wherein the first and second layers are coextruded.

4. The phosphorescent electret film of claim 2, wherein the first and second layers are heat laminated.

5. The phosphorescent electret film of claim 2, wherein the first and second layers are adhesively bonded.

6. The phosphorescent electret film of claim 2, wherein the first and second thermoplastic polymers are the same.

7. The phosphorescent electret film of claim 2, wherein the first and second thermoplastic polymers are different.

8. The phosphorescent electret film of claim 2, wherein the first and second thermoplastic polymers are different.

9. The phosphorescent electret film of claim 2, wherein the at least one of the first and second thermoplastic polymers comprises a polymer blend.

10. The phosphorescent electret film of claim 2, wherein the reflective pigment comprises at least one white pigment.

11. The phosphorescent electret film of claim 2, wherein the white pigment comprises an oxide of titanium or aluminum.

12. The phosphorescent electret film of claim 1, further comprising at least one of a heat stabilizer or a light stabilizer.

13. The phosphorescent electret film of claim 1, wherein the phosphorescent pigment has an average particle size greater than about 20 micrometers.

14. The phosphorescent electret film of claim 1, wherein the phosphorescent pigment has an average particle size greater than about 50 micrometers.

15. The phosphorescent electret film of claim 1, wherein the film is electrostatically and removably adhered to a substrate.

16. The phosphorescent electret film of claim 15, wherein the substrate is a liner or a backing sheet.

17. The phosphorescent electret film of claim 16, wherein the substrate is selected from the group consisting of an architectural surface, glass, metal, a motor vehicle, a trailer, a door, a banner, and a sign.

18. A method of making a phosphorescent electret film comprising the step of extruding a mixture of at least one thermoplastic polymer and at least one phosphorescent pigment.

19. The method of claim 18, wherein extruding comprises coextruding.

20. A method for adhering a phosphorescent electret film to a substrate comprising:
providing a phosphorescent electret film; and
electrostatically and removably adhering the phosphorescent electret film to the substrate.

21. The method of claim 20, wherein the substrate is selected from the group consisting of an architectural surface, glass, metal, a motor vehicle, a trailer, a door, a banner, and a sign.
